(19) United States
(12) Patent Application Publication
(10) Pub. No.: US 2018/0216952 A1
(43) Pub. Date: Aug. 2, 2018

(54) ROUTE SAFETY

(71) Applicant: Microsoft Technology Licensing, LLC, Redmond, WA (US)

(72) Inventors: John C. KRUMM, Redmond, WA (US); Eric J. HORVITZ, Kirkland, WA (US)

(73) Assignee: Microsoft Technology Licensing, LLC, Redmond, WA (US)

(21) Appl. No.: 15/419,787

(22) Filed: Jan. 30, 2017

(51) Int. Cl. G01C 21/34; G01C 21/28; G01C 21/36

(52) U.S. Cl. CPC G01C 21/3492; G01C 21/28; G01C 21/3694; G01C 21/367; G01C 21/3676

(57) ABSTRACT

The discussion relates to route safety. One example can obtain crash probabilities for road routes for driving between two points. The example can present multiple individual road routes that reflect both crash probabilities and estimated times between the two points. The example can receive an indication that a user selected an individual one of the multiple individual road routes. The example can provide driving instructions for the selected individual one of the multiple individual road routes.

### BACKGROUND

Vehicle crashes continue to occur throughout the world. The present discussion offers solutions to reduce the number of vehicle crashes.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. In some cases parentheticals are utilized after a reference number to distinguish like elements. Use of the reference number without the associated parenthetical is generic to the element. Further, the left-most numeral of each reference number conveys the figure and associated discussion where the reference number is first introduced.

FIG. 1 shows an example route safety visualization in accordance with some implementations of the present concepts.

FIGS. 2 and 7-8 show example flowcharts for route safety concepts in accordance with some implementations of the present concepts.

FIGS. 3-6 show example graphs relating to route safety in accordance with some implementations of the present concepts.

FIG. 9 shows an example system that can implement route safety concepts in accordance with some implementations.

### DETAILED DESCRIPTION

Vehicle crashes account for over one million fatalities and many more million injuries annually worldwide. Some roads are safer than others, so a driving route (e.g., road route or route) that is optimized for safety may reduce the number of crashes. Further, a route that considers safety in combination with other parameters can reduce the number of crashes. The present concepts can estimate the probability of a crash on any road segment as a function of various parameters, such as traffic volume, road characteristics, and/or environmental conditions, among others. Possible routes between a starting point and a destination point can be identified. The safety of the routes can be determined and compared to select a relatively safe route. In some cases, route selection can include other parameters, such as time. The concepts can smoothly trade off safety for time, giving several different route options with different crash probabilities and durations (e.g., travel times) between the two points.

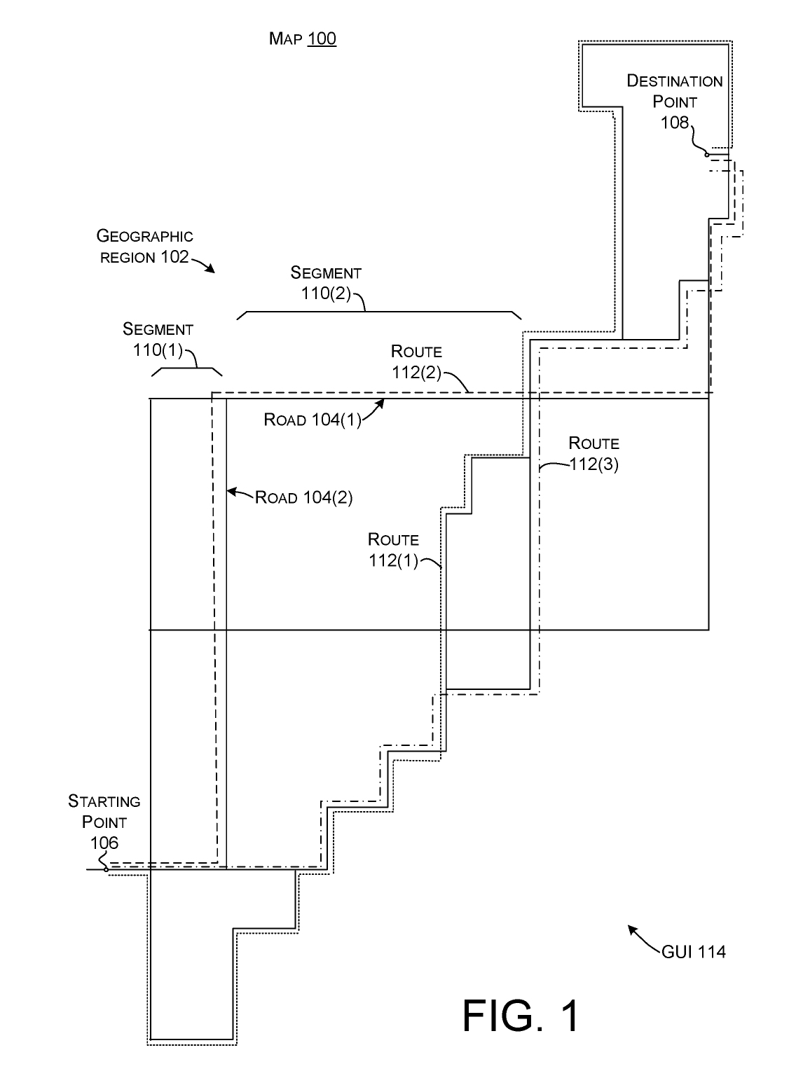

Introductory FIG. 1 shows a map 100 of a geographic region 102 that includes multiple roads 104 (solid lines)(not all roads are labeled to avoid clutter on the drawing page). Travel between a starting point 106 and a destination or end point 108 can be achieved over a subset of the roads 104. The roads 104 can be defined as road segments 110 (only two of which are designated with specificity to avoid clutter on the drawing page). A road segment 110 can be a section of road between two intersections, an intersection and a dead end, an intersection and a starting point or a destination point, and/or an intersection. Further, an intersection could be treated as multiple different road segments. For instance, travel eastbound straight through an intersection can be viewed as a different road segment than travel eastbound turning north in the intersection, which can also be viewed as a different road segment than travel eastbound turning south, etc. Various routes 112 can be calculated between the starting point and the destination point over the road segments 110.

The present implementations can identify the safety of individual routes. For instance, route 112(1) (dotted line) can be the safest route between the starting point 106 and the destination point 108. The present implementations can also identify routes based upon other parameters. For instance, route 112(2) (dashed line) can be the fastest route. The present implementations can also identify routes that consider safety as a parameter in combination with other parameters. For instance, route 112(3) (alternating dots and dashes) can balance safety and time parameters. Qualitatively, route 112(3) is almost as fast as route 112(2) and almost as safe as route 112(1). Quantitative calculations relating to route safety are described below relative to the heading “Crash Probability on Route.” Note that while routes are distinguished in the illustrated example via line pattern, other implementations can use other indicia. For instance, the fastest route could be shown in green, the safest route in red and the compromise route in amber/yellow, among other configurations.

In light of the above discussion, in some implementations, map 100 can be an example graphical user interface (GUI) 114 that can be presented to a user to convey route safety information. Other types of GUIs can be generated for, and/or presented to, the user. For instance, a GUI can be presented that allows the user to assign relative weights to different parameters (e.g., rank safety higher than time or rank time higher than safety). These ranking can then be utilized to generate the routes presented on the map 100.

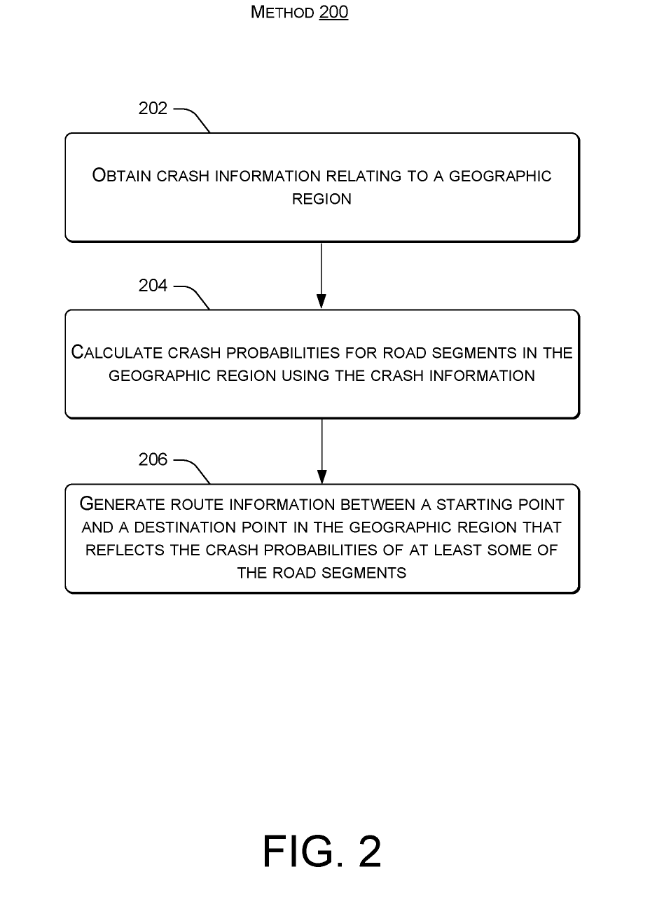

FIG. 2 relates to a method 200 involving route safety. At block 202 the method can obtain crash information relating to a geographical region. The crash information may relate to crashes at specific locations within the geographical region. The crash information may be obtained from various sources, such as private and/or public entities. For instance, assume for purposes of explanation that a user wants to travel between two points in Seattle, Wash. This geographic region may contain roads maintained by the City of Seattle, King County, Washington State, and/or the Federal Highway Administration. One or more of these entities may maintain databases of crash information for this geographic region. Alternatively or additionally, private entities, such as automobile insurance companies or travel-related companies, among others, may maintain databases that cover this geographic region. The crash information can include various facets, such as date of crash, time of day, weather conditions, severity of crash, etc. Note that other data sources can be leveraged to look up other crash information. For instance, when the location and date/time of the crash is known, some implementations can look up the corresponding weather conditions from the U.S. National Weather Service, for example. A specific example that obtains the crash information from the City of Minneapolis is described in more detail below under the heading “Crash and Traffic Data.”

At block 204 the method can calculate crash probabilities for road segments in the geographic region. In one case, the crash information relating to locations within the geographic location can be correlated to a map of roads in the geographic region to identify crashes along specific road segments. Crash probabilities for the road segments can be calculated for the present time (e.g., the time at which the travel from the starting point to the destination point is expected to occur) from the obtained crash information relating to the road segments. A specific example of calculating crash probabilities for road segments is described in more detail below relative to the heading “Individual Crash Probability on Road Segment.”

At 206 the method can generate route information between a starting point and a destination point in the geographic region that reflects the crash probabilities of at least some of the road segments. The route information can pertain to routes solely on the basis of safety (e.g., which routes are safer (and potentially safest)). An example is described above relative to FIG. 1 and below relative to the heading “Crash Probability on Route.” In other cases, the route information can pertain to routes that treat safety as a parameter that is balanced with other parameters, such as time. An example is discussed above relative to FIG. 1 and below relative to the heading “Route Length vs. Safety Tradeoff.”

### Crash and Traffic Data

As mentioned above, data on crashes and vehicle counts for a geographic region can be used to assess the probability of a crash along a route. An example geographic region for which data is available is Minneapolis, Minn. A convenient source of both crash and vehicle count data is the Traffic Data Management System of the City of Minneapolis, Minn., USA (Minneapolis). The source provided data on 15,401 vehicle crashes spanning from Jan. 1, 2013 to Jun. 30, 2015 (30 months). Since the reporting entity is the city of Minneapolis, the data does not include crashes on federal highways passing through the city, and thus federal highways are not considered in the computed routes relating to this example data.

The data available from the Minneapolis source includes hourly vehicle count data from 939 different roads over years 2012-2015. Significantly, the data does not come with an absolute date for the counts. The counts are reported as the number of vehicles traversing the road over the given hour on a given day of the week.

The final piece of input data for the geographic region can be a routable road network from a mapping database, such as the Bing® Maps database (Microsoft Corp.), Google Maps (Alphabet Inc.), etc. Connectivity can be represented as a directed graph, with intersections as vertices and road segments as edges between the vertices. In this example, each crash and traffic count can be matched to the geographically nearest road from the mapping database.

### Learning Crash Risk

The crash probability of a road segment can be estimated by first interpolating to infer the hourly vehicle count and then classifying to infer the crash probability.

### Interpolating Traffic Counts

For a given date/time on a road segment, the hourly vehicle count can be estimated. This estimated hourly vehicle count can first be used as a parameter to estimate crash risk, where it has proven to be an important feature (and potentially most important) among the various parameters considered. This estimated hourly vehicle count can also be used as part of the arithmetic to compute a crash probability: if a road segment will host one crash and N vehicles in an hour, then each vehicle on that road segment has a 1/N chance of crashing over that hour.

Due to the spatial sparsity of vehicle count sources, the road segment in question may not have a vehicle count measurement. However, if a traffic count estimate is desired for a date/time on a road segment that has been measured, the count from the traffic count data can be queried. The query can first look for a count taken in the year nearest the given date/time. Given this, the process can then look for a count in that year taken on the nearest day of week. (Recall that the traffic count data in this example does not come with absolute dates, just a year and a day of week). With this nearest year and day of week, the process can then look up the traffic count for the desired hour.

Often the road segment in question does not have a vehicle count measurement, and the hourly traffic count can be estimated on a road where the traffic count has not been measured. This can be treated as an interpolation problem, because the estimate can be made using traffic counts from roads that are nearby in space and time. Mathematically it is a regression problem, where the dependent variable/parameter is the desired traffic count, and the independent variables are features including nearby traffic counts. In this example, there are 65 independent variables in the regression function. Five of the independent variables characterize the date/time and the road segment in question: hour of day, day of week, road type from {major road, arterial, street}, number of lanes, and speed limit. Other and/or additional variables/parameters can be considered in other implementations.

Independent variables from nearby roads that have measured vehicle counts can also be considered. Specifically, the nearest five measured roads for each road type in {major road, arterial, street} can be considered, giving data on 15 total nearby roads. In this example, for each of these 15 roads, the independent variables are:
Hourly vehicle count based on the vehicle count query described above;
Great circle distance from road segment in question;
Difference in the number of lanes from road segment in question;
Difference in speed limit from road segment in question.

Thus, the total number of independent variables for the regression function is 65, in this example. The dependent variable to estimate is the hourly traffic count on the road segment in question for the specified date/time.

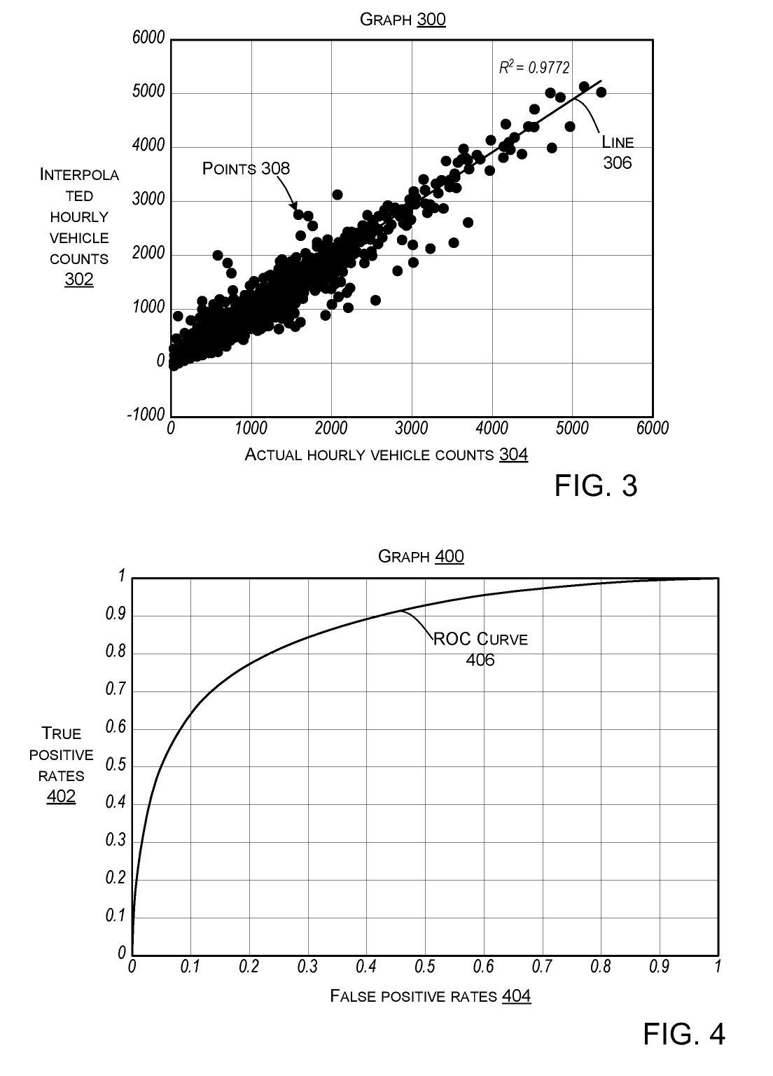

In this example, the regression function can be a boosted forest of decision trees. In some cases, parameters can be examined and/or ranked for predictive value. For instance, parameters for the learning rate and forest parameters can be examined to find the most accurate function in terms of I₁ error. In this case the optimal forest consisted of 500 trees with 74 leaves per tree and a minimum of 10 instances in each leaf. The estimates can be tested by using the learned regression function to estimate traffic counts on roads that have actual traffic count measurements. Specifically, for each measured road segment, the actual vehicle count can be extracted for each hour from our data. Using ten-fold cross validation, regression estimates can be recorded for each measured instance. The results are shown in FIG. 3, which shows a graph 300. The graph shows interpolated hourly vehicle counts 302 on the vertical axis and actual hourly vehicle counts 304 on the horizontal axis. The graph shows a good correlation between measured and estimated vehicle counts, with a linear least squares fit of R²=0.9772 as defined by line 306 through points (e.g., instances) represented generally at 308.

With this regression function in place, a vehicle count estimate can be computed for any road segment in the region for any given date/time.

### Classifying Crash Occurrence

A crash occurrence classifier can be created that identifies the risk of a crash based on the crash data. The crash occurrence classifier can be trained with positive examples from the crash data and negative examples generated randomly and uniformly in space and time. Each example can be an hour-long instance on a road segment that either did or did not host a crash. The positive examples are simply the 15,401 crashes in the data, with the date/time truncated to the previous integer hour and the location represented as the nearest road segment. In this case, it was rare to have more than one crash on the same road segment during the same hour, so all the crash examples implicitly represent a single reported crash incident. An equal number of negative crash examples can be generated in hour-long intervals and road segments that were not reported as crash occurrences. Some crashes go unreported, so there may have been some false negatives in the training data.

In this implementation, the crash occurrence classifier is based on a set of 29 features from each example, outlined below.

Vehicle Count: Vehicle count estimate from interpolation;

Date/Time: Day of week, hour of day;

Road Segment Layout: Road type from {major road, arterial, street}, number of lanes, speed limit, divider (binary), length of road segment, mean slope of road segment, minimum, maximum & mean radii of curvature;

Sun Angle: Sun above or below horizon (binary), elevation, azimuth, subtended angles between azimuth and road heading (sum to 180 degrees);

Weather: Temperature, wind speed, snow depth, visibility (miles), cloud ceiling (feet), precipitation in last hour, last 6 hours, and last 24 hours;

Nearby Structures: Number and density of residences along road segment, number and density of businesses along road segment.

Most of these features are self-explanatory. In this example, the road segment layout features, residences, and businesses came from a mapping database, such as Bing Maps road database. The features involving the sun's azimuth angle indicate the propensity for sun glare in the driver's eyes. Weather features for the Minneapolis, Minn. area were obtained from the National Oceanic and Atmospheric Administration which gives recorded weather conditions in approximately one-hour increments.

Given the features, an instance can be classified as either a crash or not. As with the regression function above, a boosted forest of decision trees can be employed, but for classification instead of regression. Different parameters can be swept with 10-fold cross validation. One example utilized a forest of 500 trees, 296 leaves per tree, and a minimum of 1 instance in each leaf.

Ten-fold cross validation gave an overall classification accuracy of 78.4%. Positive precision and recall were 79% and 77.5%, respectively, and negative precision and recall were 77.9% and 79.4%. The results are shown in FIG. 4 which shows a graph 400 that reflects true positive rates 402 on the vertical axis and false positive rates on the horizontal axis 404. The graph shows a receiver operating characteristic (ROC) curve 406 and the area under this curve is 0.863. Thus, this crash occurrence classifier gives a good idea of the conditions under which a crash is likely to occur.

### Computing Individual Crash Probability

The crash occurrence classifier can estimate the relative risk of a crash occurring on each road segment for a given hour. This section describes how the crash probability can first be computed for an individual traversing a road segment and then how the probability of a crash can be computed over a trip traversing multiple road segments.

### Individual Crash Probability on Road Segment

The probability pᵢ of a single vehicle crashing on a road segment i over a given hour can be computed. From the crash occurrence classifier above, a class probability cᵢ can be obtained that predicts crash risk given environmental features over the hour in question. This class probability pertains to the occurrence of a crash among all the vehicles on the road segment over the hour. In that hour, there are vᵢ vehicles traversing the road segment, where vᵢ comes from the interpolation estimate described previously. With pᵢ and vᵢ for the relevant hour, the class probability for any individual vehicle crash in that hour is cᵢ′=cᵢ,/vᵢ.

Neither the class probability cᵢ, nor the individual class probability cᵢ′, are calibrated to consider the overall expected number of crashes in the entire region, i.e. the city of Minneapolis in this case. Both can have an unrealistically inflated view of crash occurrences, because the crash occurrence classifier was trained on an equal number of positive and negative crash examples. In actuality, there are far fewer positive instances of crashes than negative instances. Thus, these class probabilities can be calibrated by scaling, such that the expected number of crashes over all the region's road segments is the same as the historical number of crashes over the given hour. The scale factor is ρ, and the calibrated probability of a single vehicle crashing is pᵢ=ρᵢ′. If A is the random variable representing the total number of hourly crashes in the region over an hour-long period, and E[A]=a, then

$$E [ A ] = {\sum }_{i = 1}^{s} {p}_{i} = {\sum }_{i = 1}^{s} ρ {c}_{i}^{′} = a \qquad ( 1 )$$

Here S is the total number of road segments in the region. Equation (1) provides ρ=a/Σᵢ₌₁^{S}cᵢ′. This scaling by ρ can ensure that the total number of predicted crashes matches the historical number of crashes, a, in the given hour. In this formulation, “a” is the mean number of crashes observed on the day of week and hour of day corresponding to the hour in question.

In numerical terms, the crash occurrence classifier can produce class probabilities cᵢ in the range [0,1]. Hourly road counts vᵢ are typically O(100), giving cᵢ′=cᵢ,/vᵢ a typical range of [0,O(0.01)]. Calibrating with pᵢ=ρcᵢ′ gives individual crash probabilities of roughly [0,O(10⁻⁶)].

### Crash Probability on Route

As mentioned above relative to FIG. 1, a route consists of a sequence of connected road segments. Since the order of traversal does not matter for these computations, a route can be designated as a set of road segments R, where each element of R is an index of a road segment.

The crash probability p_{R} of a route can be modeled as a set of independent Bernoulli trials, with one trial for each road segment. The probability of traversing a single road segment i without crashing is 1−pᵢ. The probability of traversing the entire route R without crashing is then Π_{i∈R}(1−pᵢ). Finally, the probability of crashing anywhere along the route is then

$${p}_{R} = 1 - {\prod }_{i ∈ R} ( 1 - {p}_{i} ) \qquad ( 2 )$$

An alternative expression for the probability of not crashing on road segment i comes from the Poisson distribution. pᵢ can be interpreted as the average number of crashes per the length of road segment i. The Poisson distribution says the probability of having k crashes on the road segment is then

$$P ( k ) = \frac{{p}_{i}^{k} {e}^{- {p}_{i}}}{k !}$$

Given this, the probability of experiencing no crash along the road segment is

P(0)=e^{-p}^{ᵢ}

This is an alternative to the above formulation which says the probability of not crashing on a road segment is 1−p₁. For small values of pᵢ, the following equation can be employed: 1−pᵢ≅e^{-p}^{ᵢ}. The remainder of this document uses 1−pᵢ, but this term could be replaced with e^{-p}^{ᵢ}.

Route Length Vs. Safety Tradeoff

Intuitively, a safe route could be one that tediously weaves a long path around unsafe road segments. However, even with smaller crash probabilities, a longer route with more road segments can lead to potentially more crash exposure. The Bernoulli probabilities make it easy to analyze this tradeoff. As a simple example, suppose that a shorter route consists of nₛₕₒᵣₜ road segments, each with an equal crash probability of pₛₕₒᵣₜ. From Equation (2), the probability of experiencing a crash on this route is pₛ=1−(1−pₛₕₒᵣₜ)ⁿ^{ₛₕₒᵣₜ}. An alternate longer route has a lower crash probability p_{long}=γpₛₕₒᵣₜ on each of its segments, with 0<γ<1. The longer route also has more road segments n_{long}=snₛₕₒᵣₜ, with s>1. The probability of experiencing a crash on the longer route is pₗ=1−(1−p_{long})ⁿ^{_{long}}=1−(1−γpₛₕₒᵣₜ)^{sn}^{ₛₕₒᵣₜ}.

Setting pₛ=pₗ gives the equivalence point where the two routes are equally safe:

1−(1−pₛₕₒᵣₜ)ⁿ^{ₛₕₒᵣₜ}=1−(1−γpₛₕₒᵣₜ)^{sn}^{ₛₕₒᵣₜ} (3)

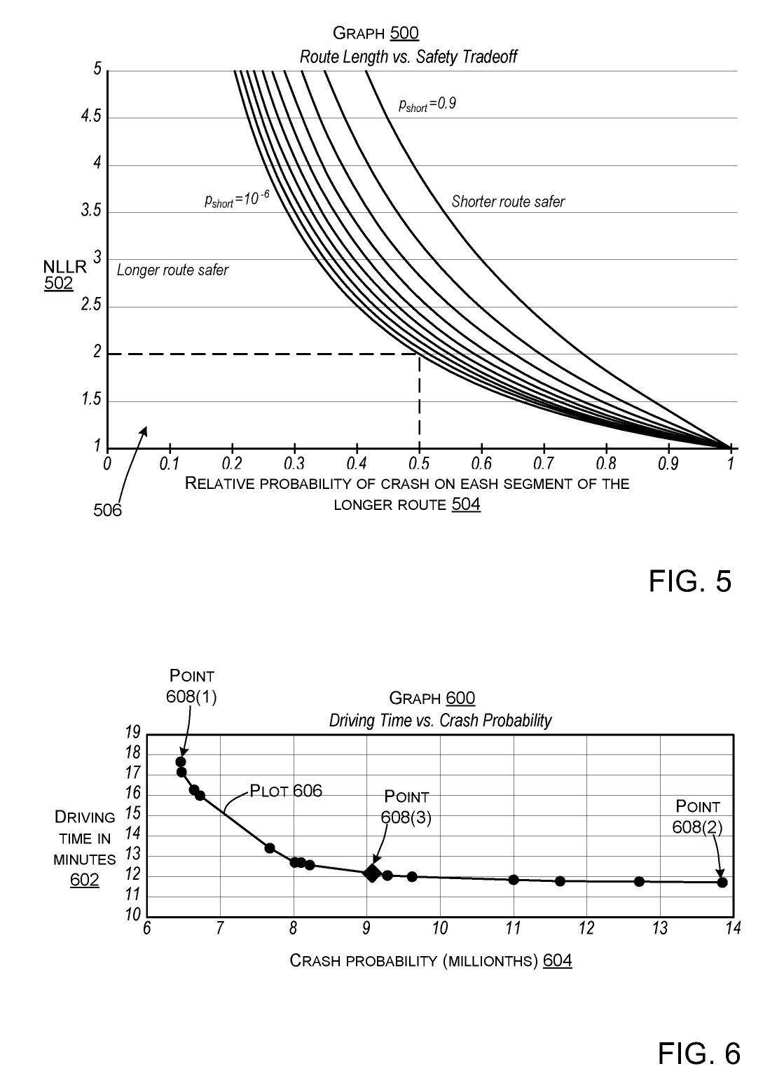

For a given value of pₛₕₒᵣₜ, values of γ and s can be computed that satisfy this equation. Plotted as ordered pairs (γ, s), points on the lower left side of this curve indicate the longer route is safer. Values on the other side indicate the shorter route is safer. This is illustrated for several values of pₛₕₒᵣₜ in FIG. 5 which shows graph 500 that conveys the route length versus safety tradeoff. The graph shows normalized length of longer route (NLLR) 502 on the vertical axis versus relative probability of crash on each segment of the longer route 504 on the horizontal axis. The lower left region 506 of the (γ, s) space represents longer routes that are not very much longer than the corresponding shorter route and whose road segment crash probabilities are significantly less than those of the corresponding shorter route. In reality, the values of pₛₕₒᵣₜ are small, O(10⁻⁵) or O(10⁻⁶), meaning the realistic tradeoff curve is toward the left of the illustrated curves.

For purposes of explanation, the case with pₛₕₒᵣₜ=10⁻⁶, which pertains to the left-most curve in FIG. 5 is examined and described in further detail. Looking at the horizontal axis at 0.5, this represents a longer route with p_{long}=0.5*pₛₕₒᵣₜ, which might be considered safer. Looking vertically from 0.5, the curve is at about s=2. This means that the longer route will be safer only if it is less than about twice the length of the shorter route. If it is over twice as long, then the longer route will be ultimately less safe, even though its constituent road segments are safer.

### Safer Driving Routes

Driving routes are often computed by minimizing a sum of costs. For computing safe routes, the probability of a crash can be used as the cost to minimize. From the Bernoulli trials formulation, the probability of a crash along a route is given by Equation (2). Even though this is not a sum, even in log space, a simple Dijkstra algorithm can still be used to compute safer (and potentially the safest) routes. An alternative algorithm could employ an A* search.

More specifically, Dijkstra's algorithm maintains a list that gives the minimum cost for traveling to each “visited” node. Normally these costs are simply the sum of individual edge costs leading to that node. In present implementations, these costs are instead the partial route crash probabilities computed from Equation (2). For computational efficiency and numerical stability, a parallel list can be maintained that gives Σ log(1−pᵢ) for the partial route to each visited node.

For purposes of explanation, 100 arbitrary start and end pair locations were picked in the study geographic region (e.g., Minneapolis) for testing. The fastest and safest routes can be computed for these start and end pair locations. The fastest (e.g., shortest time) route used only the lengths and speed limits of the road segments to estimate traversal time. Note that in this example the fastest route computation did not account for turns, traffic lights, traffic congestion, or other delays. Thus, they are independent of the time of day. FIG. 1 shows one example set of routes between the same endpoints.

The hours of 4 a.m., 8 a.m., and 6 p.m. on Tuesday, Jan. 20, 2015, were examined to demonstrate the results. For each time of day, Table 1 shows the mean driving times and mean crash probabilities for the 100 test routes. Table 1 also shows the relative multiples between the driving times and crash probabilities between the fastest and safest routes. On average, the safest route takes 1.69 times as long to drive and has 0.53 times the crash probability, illustrating the tradeoff between driving time and safety. The mean crash probability of the fastest routes is 8.9×10⁻⁶, and the mean crash probability of the safest routes is 4.6×10⁻⁶.

TABLE 1

| | Fastest Route | | Safest Route | | Fastest to | Fastest to Safest |
|---|---|---|---|---|---|---|
| | Duration | Crash | Duration | Crash | Safest Driving | Crash Probability |
| Hour of Day | (minutes) | Probability | (minutes) | Probability | Time Multiple | Multiple |
| 4 a.m. | 13.14 | 0.0000098 | 20.68 | 0.0000047 | 1.56 | 0.52 |
| 8 a.m. | 13.14 | 0.0000108 | 22.04 | 0.0000060 | 1.66 | 0.57 |
| 6 p.m. | 13.14 | 0.0000062 | 24.83 | 0.0000031 | 1.85 | 0.51 |
| Mean | 13.14 | 0.0000089 | 22.52 | 0.0000046 | 1.69 | 0.53 |

It is possible to find routes that are between the safest and fastest, incurring a certain driving time penalty for a certain safety benefit. These multi-parameter or ‘balanced’ routes can be computed by using a cost function that includes both driving time and crash probability. Specifically, the cost function can be represented as

$$α {p}_{R} + ( 1 - α ) {\sum }_{i ∈ R} {T}_{i} \qquad ( 4 )$$

Here p_{R} is the crash probability along a route whose edge indices are in set R, as given by Equation (2). The Tᵢ are the costs of the route's edges in terms of driving time, and they sum in the usual way. The variable 0≤α≤1 is a blending parameter that controls the tradeoff between crash probability and driving time. Note also that the driving time part of the cost function could be any available cost function, including those that take into account delays due to traffic, turns, and other factors.

Alternatively, a cost function of the form below can be employed:

$$αβ {p}_{R} + ( 1 - α ) {\sum }_{i ∈ R} {T}_{i}$$

This is similar to the previous cost function, but with the added parameter β. β is an optional parameter that helps equalize the numerical magnitude of p_{R} and Σ_{i∈R}Tᵢ. The crash probability p_{R} is usually O(10⁻⁵) or (10⁻⁶), and the driving time in seconds is usually O(10²) or O(10³). Without) β, the driving time can dominate for almost the whole range of α. If this technique sets β=Σ_{i∈R} Tᵢ/p_{R}, then the full range of a has a better chance of producing different routes. However, the method still holds for β=1.

The cost function in Equation (4) can be used to compute routes for the endpoints shown in FIG. 1 over 0≤α≤1. The resulting tradeoff between driving time and crash probability is shown in FIG. 6 as graph 600. The graph 600 shows driving time 602 on the vertical axis versus crash probability 604 on the horizontal axis. The graph 600 shows a plot 606 generated from multiple points 608 (not all of which are designated with specificity). The graph shows that lower crash probabilities are accompanied by longer driving times, as seen on the left side of plot 606. See for example leftmost point 608(1) (e.g., longest route in driving time). The curve of the plot 606 flattens as the driving time drops toward its minimum and crash probability rises (represented by point 608(2) on the extreme right). There are many compromise routes (represented as points on the plot interposed between point 608(1) and point 608(2)) whose driving times are approximately 12 minutes, but whose crash probability varies considerably. The fastest route, represented as the point 608(2) farthest to the right in the plot, has a crash probability of 13.8×10⁻⁶ and a driving time of 11.7 minutes. Moving left from this point, the diamond-shaped point 608(3) represents a compromise route with a driving time of 12.2 minutes (30 seconds longer than the fastest route) and a crash probability of 9.1×10⁻⁶, which is a 34% reduction. Many drivers would likely consider this a worthwhile tradeoff. This compromise route is shown in FIG. 1 as route 112(3). The compromise route 112(3) partially overlaps both the safest and fastest routes 112(1) and 112(2), respectively.

The discussion has shown how to use recorded data from vehicle crashes and vehicle counts to compute the probability of a crash along a driving route. This can involve estimating hourly traffic counts on unmeasured roads using a learned regression function and estimating crash risk as a function of environmental conditions using a crash occurrence classifier. The discussion showed how to use results from the crash occurrence classifier to estimate Bernoulli crash probabilities along segments of road and how to combine these probabilities to compute the crash probability of a route. These crash probabilities can be used in a Dijkstra algorithm to compute the safest route between two points as well as find compromise routes that trade off driving time for safety. Some implementations can employ a routing application that presents a user with this tradeoff, giving the driver the flexibility to make the tradeoff explicitly along with the knowledge of how their choice affects their safety. The route safety consideration can also be utilized in autonomous driving scenarios. Further, at such a time as adoption of route safety is high enough to affect traffic flows, dynamic balancing could be performed. For instance, if two routes each satisfy the user's safety preferences, but one route is congested and the other is not, the latter route could be suggested for the user over the former.

In the detailed example described above relating to Minneapolis, the crash information was limited. Results obtained from the present implementations could be improved with richer crash details. The severity of each crash and the number of vehicles involved would help refine the crash probability computations. Similarly, if the crash information explicitly stated which crashes occurred in the act of turning a corner, turn safety could be incorporated into the crash probability cost.

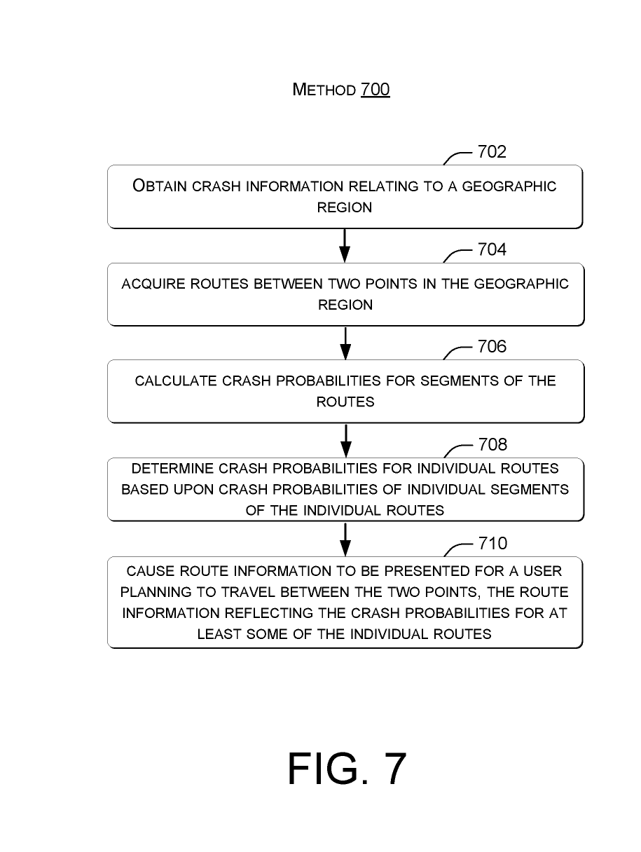

FIG. 7 illustrates a first flowchart of a technique or method 700 relating to crash probability.

At block 702, the method can obtain crash information relating to a geographic region. In some cases, the crash information can be obtained by accessing a database populated by a transportation entity, a police entity, an emergency medical services entity, and/or an insurance entity. For instance, the database may be accessible at a website.

At block 704, the method can acquire routes between two points in the geographic region. In some cases, the routes can be acquired from a mapping entity. In other cases, the routes can be generated from information relating to the geographic region.

At block 706, the method can calculate crash probabilities for segments of the routes. In some cases, the calculating can consider past crash data, crash severity, weather conditions, and/or sun angle, among other parameters.

At block 708, the method can determine crash probabilities for individual routes based upon crash probabilities of individual segments of the individual routes. In some cases, the relative crash probabilities for individual routes can be determined by identifying a sum of the individual segments of the individual routes.

At block 710, the method can cause route information to be presented for a user planning to travel between the two points. The route information reflects the crash probabilities for at least some of the individual routes. In some cases the route information can be made available on a website or cloud-based service which can be accessed via a device, such as a user device. For instance, an app on the user's device may operate cooperatively with the cloud-based service. The cloud-based service can generate the routes which can be sent to the user's device and then the device can present the routes to the user.

The route information can be presented on a graphical user interface (GUI) on the user's device, such as in the form or a map and/or driving instructions. In one implementation, the GUI can show an individual route having a relatively low crash probability or the GUI can show multiple individual routes and convey relative crash probabilities of the multiple individual routes. The multiple individual routes can consider crash probability as a parameter and each route of the multiple individual routes can reflect multiple parameters. In some cases the parameters can be weighted equally. In other cases the multiple parameters can be weighted differently in different individual routes. For instance, an individual route could be shown that weights time (of travel) higher than safety, while another individual route weights safety higher than time. The weights could be determined automatically and/or the weights can be selected and/or adjusted by the user.

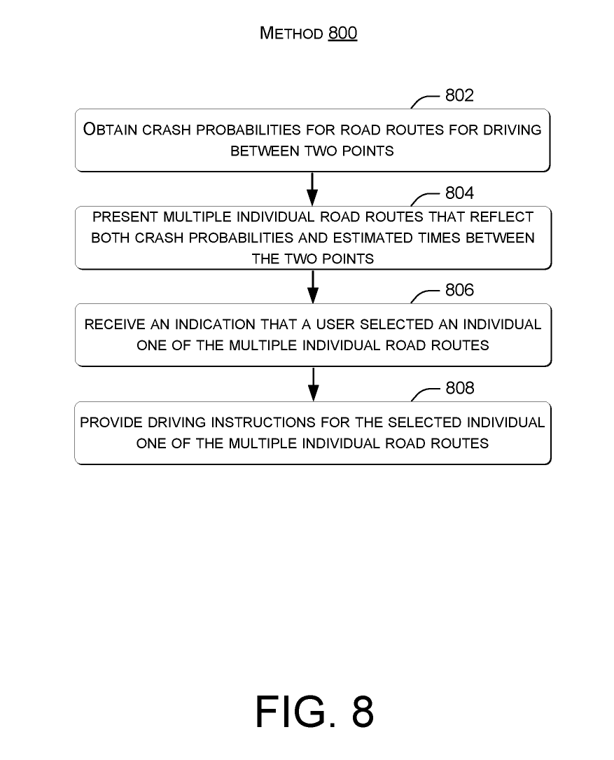

FIG. 8 illustrates another flowchart of a technique or method 800 relating to crash probability.

At block 802, method 800 can obtain crash probabilities for road routes for driving between two points. In some cases, the crash probabilities can be calculated for the routes from crash probabilities of road segments of the road routes. In other cases, the crash probabilities can be obtained for the road routes from a database or a website.

At block 804, the method can present multiple individual road routes that reflect both crash probabilities and estimated times between the two points. In some cases, the multiple individual road routes can be presented in different colors that reflect a relative safety of the individual road routes.

At block 806, the method can receive an indication that a user selected an individual one of the multiple individual road routes. For instance, the user may click on one of the presented routes.

At block 808, the method can provide driving instructions for the selected individual one of the multiple individual road routes to aid the user in reaching the destination.

The described methods can be performed by the systems and/or elements described above and/or below, and/or by other devices and/or systems. For instance, in one case, an entity, such as an automobile insurance provider may have an app that runs on the user's device (e.g., smartphone or the car itself). The app may track the user's location, weather conditions, etc. If the user enters a request for a route between two points and/or the provider identifies that the user is traveling between two points (e.g., work and home) the provider may offer routes on the device that consider safety. In some cases, the provider may offer incentives if the user travels suggested safe routes. In another case, the user may subscribe to a driving app on his/her device or car that provides routes between locations. The app may operate cooperatively with cloud-based resources to access crash info that can be used to identify routes for the user that reflect relative safety. Alternatively, an entity, such as a road department or an emergency service provider may calculate and/or utilize route safety as a tool to influence where to allocate resources (e.g., which roads to improve with existing budget dollars to make them safer or where to place a tow truck, ambulance, or fire station).

The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on one or more computer-readable storage medium/media as a set of instructions (e.g., computer-readable instructions or computer-executable instructions) such that execution by a processor of a computing device causes the computing device to perform the method.

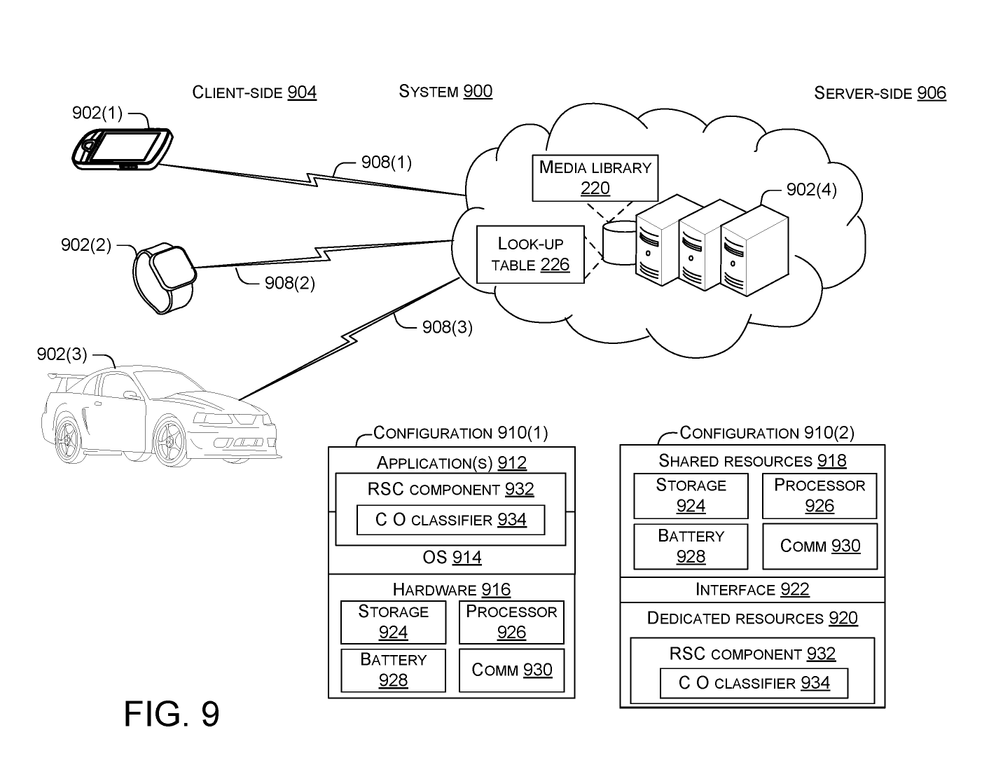

FIG. 9 shows a system 900 that can accomplish crash probability concepts. For purposes of explanation, system 900 includes devices 902(1), 902(2), 902(3), and 902(4). In this example, device 902(1) is manifest as a smartphone device, example device 902(2) is manifest as a wearable smart device, example device 902(3) is manifest as a vehicle, and example device 902(4) is manifest as a server device. For purposes of explanation devices 902(1)-902(3) can be viewed as being positioned on a client or user side 904 and device 902(4) is positioned in remote server-side or cloud-based resources side 906. The number and/or positioning of illustrated devices is intended to be representative and non-limiting. Devices 902 can communicate via one or more networks (represented by lightning bolts 908) and/or can access the Internet over the networks. In some cases, parentheticals are utilized after a reference number to distinguish like elements. Use of the reference number without the associated parenthetical is generic to the element.

FIG. 9 shows two device configurations 910 that can be employed by devices 902. Individual devices 902 can employ either of configurations 910(1) or 910(2), or an alternate configuration. (Due to space constraints on the drawing page, one instance of each configuration is illustrated rather than illustrating the device configurations relative to each device 902). Briefly, device configuration 910(1) represents an operating system (OS) centric configuration. Configuration 910(2) represents a system on a chip (SOC) configuration. Configuration 910(1) is organized into one or more applications 912, operating system 914, and hardware 916. Configuration 910(2) is organized into shared resources 918, dedicated resources 920, and an interface 922 there between.

In either configuration 910, the device can include storage/memory 924, a processor 926, a battery (or other power source) 928, a communication component 930, and/or a route safety component (RSC) 932. The route safety component can include an instance of a crash occurrence classifier 934 (introduced but not designated above). The route safety component can also include and/or access crash information. In this case, the crash information is included in a crash database that can be accessed via a website. In some cases, the route safety component 932 can be part of, or work cooperatively with, a mapping entity/service, such as a driving app, that can exist on a client device and/or on the cloud-based resources 906. The route safety component can coordinate these aspects to produce route crash information for the user, such as in the form of a GUI (114, FIG. 1).

In some configurations, each of devices 902 can have an instance of the route safety component 932. However, the functionalities that can be performed by individual route safety components 932 may be the same or they may be different from one another. For instance, in some cases, each device's route safety component can be robust and provide all functionality described above and below (e.g., a device-centric implementation). In other cases, some devices can employ a less robust instance of the route safety component that relies on some functionality to be performed remotely (e.g., an app-centric implementation that relies on remote (e.g., cloud) processing).

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

Examples of devices 902 can include traditional computing devices, such as personal computers, desktop computers, servers, notebook computers, cell phones, smart phones, personal digital assistants, pad type computers, mobile computers, cameras, appliances, smart devices, IoT devices, vehicles, etc. and/or any of a myriad of ever-evolving or yet to be developed types of computing devices.

As mentioned above, configuration 910(2) can be thought of as a system on a chip (SOC) type design. In such a case, functionality provided by the device can be integrated on a single SOC or multiple coupled SOCs. One or more processors 926 can be configured to coordinate with shared resources 918, such as memory/storage 924, etc., and/or one or more dedicated resources 920, such as hardware blocks configured to perform certain specific functionality. Thus, the term “processor” as used herein can also refer to central processing units (CPUs), graphical processing units (GPUs), controllers, microcontrollers, processor cores, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

Various examples are described above. Additional examples are described below. One example includes at least one computer-readable storage medium having instructions stored thereon that, when executed by a computing device, cause the computing device to perform acts, comprising obtaining crash information relating to a geographic region, acquiring routes between two points in the geographic region, and calculating crash probabilities for segments of the routes. The acts further comprise determining crash probabilities for individual routes based upon crash probabilities of individual segments of the individual routes, and causing route information to be presented for a user planning to travel between the two points, the route information reflecting the crash probabilities for at least some of the individual routes.

Another example can include any of the above and/or below examples where the obtaining crash information comprises accessing a database populated by a transportation entity, a police entity, an emergency medical services entity, a driving application entity, a mapping entity, and/or an insurance entity.

Another example can include any of the above and/or below examples where the acquiring routes comprises generating the routes or acquiring the routes from a mapping entity.

Another example can include any of the above and/or below examples where the calculating crash probabilities considers past crash data, crash severity, weather conditions, and/or sun angle.

Another example can include any of the above and/or below examples where the determining relative crash probabilities for individual routes comprises identifying a sum of the individual segments of the individual routes.

Another example can include any of the above and/or below examples where the causing route information to be presented comprises presenting a graphical user interface (GUI) on a user device.

Another example can include any of the above and/or below examples where the GUI shows an individual route having a relatively low crash probability.

Another example can include any of the above and/or below examples where the GUI shows multiple individual routes and conveys relative crash probabilities of the multiple individual routes.

Another example can include any of the above and/or below examples where the multiple individual routes consider crash probability as a parameter, and each route of the multiple individual routes reflects multiple parameters, and where the multiple parameters are weighted differently in different individual routes.

Another example can include any of the above and/or below examples where a first individual route of the multiple individual routes weights crash probability higher than time, and a second individual route of the multiple individual routes weights time higher than crash probability.

Another example can include any of the above and/or below examples where the causing route information to be presented comprises sending the route information to a user device.

Another example can include any of the above and/or below examples where the causing route information to be presented comprises making the route information available on a website.

Another example can include any of the above and/or below examples where the causing route information to be presented comprises making the route information available on a cloud-based service.

Another example can include a method comprising obtaining crash probabilities for road routes for driving between two points, presenting multiple individual road routes that reflect both crash probabilities and estimated times between the two points, receiving an indication that a user selected an individual one of the multiple individual road routes, and providing driving instructions for the selected individual one of the multiple individual road routes.

Another example can include any of the above and/or below examples where the obtaining comprises calculating the crash probabilities for the road routes from crash probabilities of road segments of the road routes.

Another example can include any of the above and/or below examples where the obtaining comprises obtaining the crash probabilities for the road routes from a database or a website.

Another example can include any of the above and/or below examples where the presenting comprises presenting the multiple individual road routes in different colors that reflect a relative safety.

Another example can include a system comprising storage storing computer-executable instructions for obtaining crash information relating to a geographic region, calculating crash probabilities for road segments in the geographic region using the crash information, and generating route information between a starting point and a destination point in the geographic region that reflects the crash probabilities of at least some of the road segments. The system further comprises a processing device that executes the computer-executable instructions.

Another example can include any of the above and/or below examples where the system is embodied on a user device.

Another example can include any of the above and/or below examples where the system is embodied on cloud-based resources.

### CONCLUSION

Although the subject matter relating to route safety has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. At least one computer-readable storage medium having instructions stored thereon that, when executed by a computing device, cause the computing device to perform acts, comprising:
obtaining crash information relating to a geographic region;
acquiring routes between two points in the geographic region;
calculating crash probabilities for segments of the routes;
determining crash probabilities for individual routes based upon crash probabilities of individual segments of the individual routes; and,
causing route information to be presented for a user planning to travel between the two points, the route information reflecting the crash probabilities for at least some of the individual routes.

2. The at least one computer-readable storage medium of claim 1, wherein the obtaining comprises accessing a database populated by a transportation entity, a police entity, an emergency medical services entity, and/or an insurance entity.

3. The at least one computer-readable storage medium of claim 1, wherein the acquiring comprises generating the routes or acquiring the routes from a mapping entity.

4. The at least one computer-readable storage medium of claim 1, wherein the calculating considers past crash data, crash severity, weather conditions, and/or sun angle.

5. The at least one computer-readable storage medium of claim 1, wherein the determining relative crash probabilities for individual routes comprises identifying a sum of the individual segments of the individual routes.

6. The at least one computer-readable storage medium of claim 1, wherein the causing route information to be presented comprises presenting a graphical user interface (GUI) on a user device.

7. The at least one computer-readable storage medium of claim 6, wherein the GUI shows an individual route having a relatively low crash probability.

8. The at least one computer-readable storage medium of claim 6, wherein the GUI shows multiple individual routes and conveys relative crash probabilities of the multiple individual routes.

9. The at least one computer-readable storage medium of claim 8, wherein the multiple individual routes consider crash probability as a parameter and each route of the multiple individual routes reflects multiple parameters and wherein the multiple parameters are weighted differently in different individual routes.

10. The at least one computer-readable storage medium of claim 9, wherein a first individual route of the multiple individual routes weights crash probability higher than time and a second individual route of the multiple individual routes weights time higher than crash probability.

11. The at least one computer-readable storage medium of claim 1, wherein the causing route information to be presented comprises sending the route information to a user device.

12. The at least one computer-readable storage medium of claim 1, wherein the causing route information to be presented comprises making the route information available on a cloud-based service.

13. The at least one computer-readable storage medium of claim 1, wherein the causing route information to be presented comprises making the route information available on a website.

14. A method, comprising:
obtaining crash probabilities for road routes for driving between two points;
presenting multiple individual road routes that reflect both crash probabilities and estimated times between the two points;
receiving an indication that a user selected an individual one of the multiple individual road routes; and,
providing driving instructions for the selected individual one of the multiple individual road routes.

15. The method of claim 14, wherein the obtaining comprises calculating the crash probabilities for the road routes from crash probabilities of road segments of the road routes.

16. The method of claim 14, wherein the obtaining comprises obtaining the crash probabilities for the road routes from a database or a website.

17. The method of claim 14, wherein the presenting comprises presenting the multiple individual road routes in different colors that reflect a relative safety.

18. A system, comprising:
storage storing computer-executable instructions for:
obtaining crash information relating to a geographic region;
calculating crash probabilities for road segments in the geographic region using the crash information;
generating route information between a starting point and a destination point in the geographic region that reflects the crash probabilities of at least some of the road segments; and,
a processing device that executes the computer-executable instructions.

19. The system of claim 18, embodied on a user device.

20. The system of claim 18, embodied on cloud-based resources.
